(19) United States
(12) Patent Application Publication
(10) Pub. No.: US 2020/0120557 A1
(43) Pub. Date: Apr. 16, 2020

(54) WIRELESS COMMUNICATION METHOD AND WIRELESS COMMUNICATION DEVICE

(71) Applicant: Sony Corporation, Tokyo (JP)

(72) Inventors: Yuan ZHANG, Nanjing (CN); Pen-Shun LU, Beijing (CN)

(73) Assignee: Sony Corporation, Tokyo (JP)

(21) Appl. No.: 16/611,864

(22) PCT Filed: Apr. 23, 2018
(86) PCT No.: PCT/CN2018/084005

§ 371 Date: Nov. 8, 2019

(30) Foreign Application Priority Data
Jun. 7, 2017 (CN) 201710422338.X

(51) Int. Cl. H04W 36/00

(52) U.S. Cl. CPC H04W 36/0058; H04W 36/0009; H04W 36/00837; H04W 36/0094

(57) ABSTRACT

Disclosed are a wireless communication method and a wireless communication device. The communication method is executed by a base station, and comprises: measuring the quality of reception of an uplink reference signal broadcast by a terminal device; when the measured quality of reception is lower than a pre-set first threshold, generating an initial message, wherein the initial message is used for instructing a neighbouring base station to measure the quality of reception of the uplink reference signal; and based on a reply message from the neighbouring base station, determining whether to instruct the terminal device to switch to the neighbouring base station, wherein the reply message indicates the quality of reception measured by the neighbouring base station.

### FIELD

The present disclosure relates to a wireless communication method and a wireless communication device, and in particular to a method and a communication device for performing handover based on uplink measurement in a mobile communication system.

### BACKGROUND

Handover is an important operation in the mobile communication system. For the future cellular system, it has put forward higher requirement for delay, signaling overhead and energy efficiency during a handover process. Therefore, the third generation partnership project (3GPP) has considered to introduce a handover process based on uplink measurement in the cellular system.

In the conventional cellular system, handover is generally performed based on downlink measurement. Specifically, user equipment receives downlink reference signals transmitted from respective base stations, and measures reception quality for the down reference signals. If it is detected that the measurement result for a source base station (that is, a base station currently providing service for the user equipment) becomes worse, while the measurement result for a certain neighbor base station (that is, a target base station) becomes better, the user equipment reports the measurement results to the source base station. The source base station determines, based on the received measurement results, whether the user equipment should perform handover and which base station is a target base station for the handover, thereby performing the handover process.

Unlike the handover performed based on downlink measurement, in a handover process based on uplink measurement, the user equipment transmits uplink reference signals, and the base stations receive the uplink reference signals and measure reception quality for the uplink reference signals. From an angle of the system, when the measurement result of the source base station is worse than a measurement result of a certain candidate target base station, the user equipment should be handover to a target base station with a better measurement result. However, since the measurement results are distributed among respective base stations during the uplink measurement-based handover process, it is difficult for the source base station to obtain the measurement results of the candidate target base stations, and thus it is difficult to perform handover decision.

If the future cellular system is in central control mode (that is, all the base stations are controlled by a certain background center), the above problem may be solved easily. For example, since the background center may obtain information from all base stations, handover decision can be performed. However, in a case that the cellular system includes movable cells, the above problem becomes more prominent. This is mainly because that the movable cells may be deployed in a scenario without the background center or a scenario in which the background center is damaged. In these scenarios, no network entity can obtain information from all the base stations, and thus handover decision cannot be performed.

Therefore, it is expected to provide a solution for effectively performing handover based on uplink measurement in the scenario without the background control center.

### SUMMARY

According to an aspect of the present disclosure, a communication method performed by a base station is provided, which includes: measuring a first reception quality of an uplink reference signal broadcasted by a terminal device; generating an initial message for instructing a neighbor base station to measure a second reception quality of the uplink reference signal, when the first measured reception quality is lower than a preset first threshold; determining whether to instruct the terminal device to handover to the neighbor base station based on a response message from the neighbor base station, where the response message indicates the second reception quality measured by the neighbor base station.

According to another aspect of the present disclosure, a communication method performed by a base station is provided, which includes: measuring a first reception quality of an uplink reference signal broadcasted by a terminal device upon receipt of an initial message from a neighbor base station; and generating a response message indicating the measured first reception quality to transmit the response message to the neighbor base station, where the neighbor base station generates the initial message based on a second reception quality of the uplink reference signal measured by the neighbor base station.

According to another aspect of the present disclosure, a base station is provided, which includes a processing circuitry configured to perform the communication method described above.

According to another aspect, a computer-readable recording medium storing a program is provided, and the program, when being executed, causes a computer to execute the communication method described above.

### BRIEF DESCRIPTION OF THE DRAWINGS

The present disclosure may be understood better with reference to the description below made in conjunction with the drawings. Throughout all the drawings, the same or similar reference numeral indicates the same or similar component. The drawings together with the following detailed illustration are included in the specification and form a part of the specification, and are used to further illustrate preferred embodiments of the present disclosure and explain principles and advantages of the present disclosure. In the drawings:

FIG. 1 schematically shows a scenario of handover based on uplink measurement;

FIG. 2 shows a signaling flow of a handover process based on uplink measurement;

FIG. 3 shows a signaling interaction flow for performing handover decision according to a first embodiment of the present disclosure;

FIG. 4 shows a curve indicating change of measurement results of base station A and base station B and corresponding signaling interaction according to the first embodiment of the present disclosure;

FIG. 5 shows a signaling interaction flow for performing handover decision according to a second embodiment of the present disclosure;

FIG. 6 shows a curve indicating change of measurement results of base station A and base station B and corresponding signaling interaction according to the second embodiment of the present disclosure;

FIG. 7 shows a signaling interaction flow for performing handover decision according to a third embodiment of the present disclosure;

FIG. 8 shows a curve indicating change of measurement results of base station A and base station B and corresponding signaling interaction according to the third embodiment of the present disclosure;

FIG. 9 shows a block diagram of a schematic configuration of an eNB, as an example of base station;

FIG. 10 shows a block diagram of a schematic configuration of a smartphone, as an example of user equipment; and

FIG. 11 shows a block diagram of a schematic configuration of computer hardware.

### DETAILED DESCRIPTION

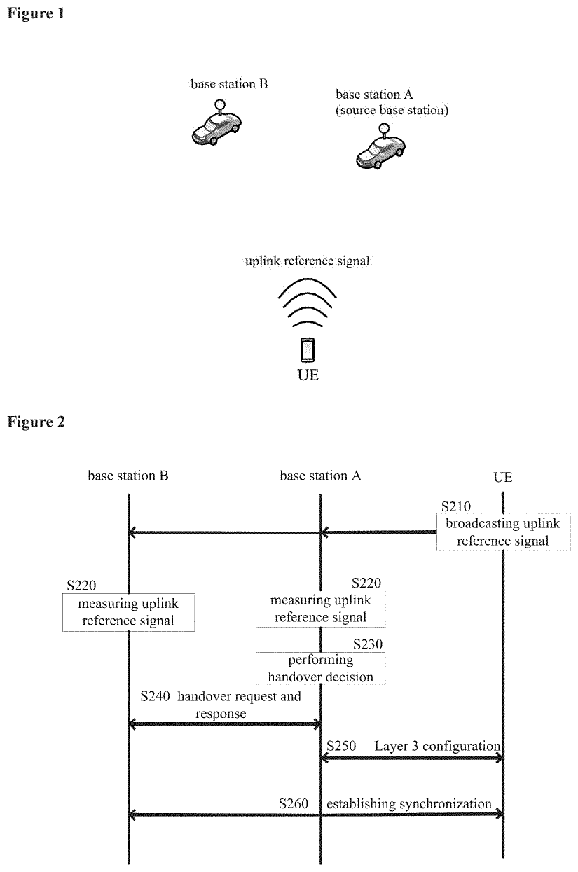

FIG. 1 shows a scenario of handover based on uplink measurement. As shown in FIG. 1, a communication system includes user equipment UE and two neighbor base stations A and B. The base station A is a base station currently providing service for the user equipment UE, that is, a source base station. As shown in FIG. 1, the base stations A and B may be, for example, mobile base stations installed on a vehicle, which are not limited in the present disclosure. Solutions of the present disclosure also adapt to a case that the base stations A and B are fixed base stations. That is, for a movable cell described above (without a background control center), the problem of performing handover decision by the source base station can be solved according to the present disclosure; in addition, for a fixed cell (with a background control center), the solutions of the present disclosure are also applicable.

In FIG. 1, the user equipment UE transmits an uplink reference signal, the base station A and the base station B each receive the uplink reference signal and measure a reception quality of the uplink reference signal. For ease of description, a measurement result of the mobile base station A is indicated by X_{A}, and a measurement result of the mobile terminal B is indicated by X_{B}. From an angle of the communication system, it is expected that in a case that the signal reception quality measured by the base station A is lower than the signal reception quality measured by the base station B by a certain amount, that is, when X_{A}<X_{B}—O is met, the base station A performs handover decision to instruct the user equipment UE to handover to the target base station B. Herein, O represents a preset threshold, and the threshold may be set based on at least one of radius of a cell, transmission power, electromagnetic wave propagation environment, requirement on signal to interference ratio, and experience and preference of an operator.

FIG. 2 shows a signaling flow of a handover process. As shown in FIG. 2, the user equipment UE transmits (for example, broadcasts) an uplink reference signal in step S210. The base station A and the base station B each measure reception quality for the received uplink reference signal, for example, power of the received signal, in step S220. Then, the source base station A manages to perform handover decision in step S230. In a case that the source base station A determines that the user equipment UE should handover to the target base station B, the source base station A and the target base station B exchange signaling with each other, and perform handover request and response in step S240. Then, the source base station A and the user equipment UE exchange signaling to perform layer-3 configuration in step S250. Then, the user equipment UE manages to synchronize with the target base station B in step S260, and accordingly communicates with the target base station B. With the above process, the user equipment UE handovers from the source base station A to the target base station B.

It follows from FIG. 2 that, the handover decision performed by the source base station A in step S230 is important, and details are described in the following.

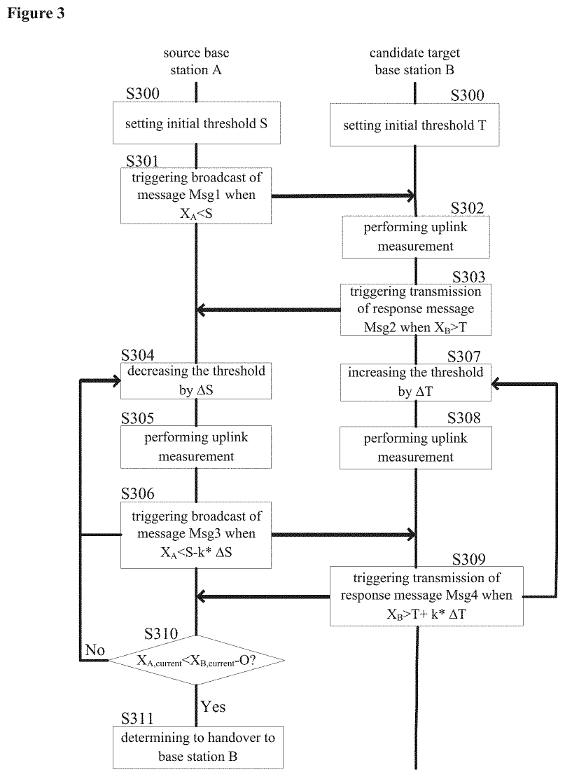

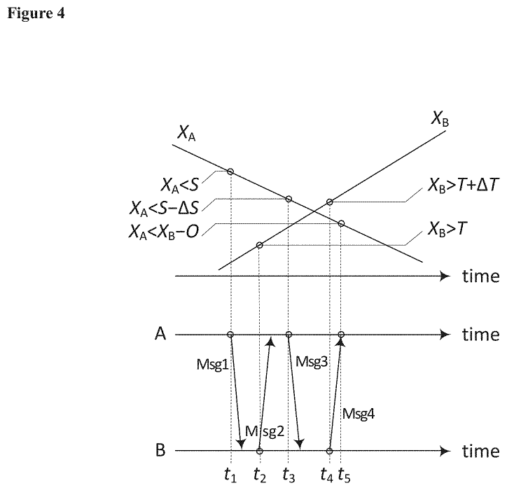

FIG. 3 shows a signaling interaction flow for performing handover decision according to a first embodiment of the present disclosure.

Reference is made to FIG. 3. First, in step S300, the source base station A sets an initial threshold S, and a candidate target base station B also sets an initial threshold T. The thresholds S and T may be set based on radius of a cell, transmission power, electromagnetic wave propagation environment and requirement on signal to interference ratio and the like. In a case that a measurement result X_{A} for an uplink reference signal transmitted to user equipment from the source base station A is lower than the initial threshold S, that is, when X_{A}<S, the source base station A triggers broadcast of an initial message Msg1 containing its measurement result to all candidate target base stations in step S301. The initial message Msg1 is used to indicate all candidate target base stations that a communication quality of the source base station A reduces, and to instruct each candidate target base station to perform uplink measurement, thereby facilitating preparing for possible handover. It should be understood by those skilled in the art that an actual communication system generally includes multiple candidate target base stations, and the measurement result of the source base station A is notified to each candidate target base station through the message Msg1. In the specification, only the base station B is schematically shown as representative of the candidate target base stations in the figure and other candidate target base stations are omitted for clarity.

After receiving the message Msg1 from the source base station A, the candidate target base station B performs uplink measurement in step S302. In a case that a measurement result X_{B} of the base station B is higher than the initial threshold T, that is, when X_{B}>T, the base station B triggers transmission of a response message Msg2 containing its measurement result to the source base station A in step S303.

The source base station A decreases its threshold by ΔS after each triggering. Therefore, the source base station A decreases its threshold by ΔS after transmission of the message Msg1, as shown in step S304. Since the user equipment periodically transmits the uplink reference signal, the source base station A periodically performs the uplink measurement. Based on this, the source base station A performs the uplink measurement after decreasing the threshold by ΔS, as shown in step S305. In a case that the source base station A detects that the current measurement result is lower than the current threshold, that is, when X_{A}<S−ΔS, the source base station A triggers broadcast of a message Msg3 containing the current measurement result to all candidate target base stations in step S306. Then, the source base station A decreases the threshold by ΔS again, and the decreased threshold becomes S−2*ΔS. Then, the source base station A performs operations of steps S305 to S306. It follows that, the source base station A decreases the threshold by ΔS and detects that the current measurement result is lower than the decreased threshold (that is, S−k*ΔS, k=1, 2, 3 . . . ), thus the source base station A triggers transmission of the message Msg3 and then decreases the threshold by ΔS again. The above process may be repeated for multiple times.

In another aspect, the candidate target base station B increases the threshold by ΔT after each triggering. Therefore, the base station B increases its threshold by ΔT after transmission of the response message Msg2, as shown in step S307. Similar to the source base station A, the base station B also periodically performs the uplink measurement. Therefore, the base station B performs the uplink measurement after increasing the threshold by ΔT, as shown in step S308. In a case that the base station B detects that the current measurement result is higher than the current threshold, that is, when X_{B}>T+ΔT, the base station B triggers transmission of a response message Msg4 containing the current measurement result to the source base station A in step S309. Then, the base station B increases the threshold by ΔT, the increased threshold becomes T+2*ΔT. Then, the base station B performs operations of steps S308 to S309. It follows that, similar to operations of the source base station A, the candidate target base station B increases the threshold by ΔT and detects that the current measurement result is higher than the increased threshold (that is, T+k*ΔT, k=1, 2, 3 . . . ), thus the base station B triggers transmission of the response message Mgs4 and then increases the threshold by ΔT again. The above process may be repeated for multiple times.

The parameters ΔS and ΔT may be set by the base station based on a speed of the user equipment. In addition, it should be noted that, although step S306 in which the source base station A transmits the message Msg3 is before step S309 in which the candidate target base station B transmits the response message Msg4 in FIG. 3, an order for performing step S306 and S309 is not limited. Since the base station A and the base station B independently perform uplink measurement and triggering, step 306 and step 309 may be performed simultaneously or in an order opposite to that shown in FIG. 3.

On receipt of the response message Msg4 from the candidate target base station B, the source base station A compares its current measurement result with the measurement result of the base station B included in the received response message Msg4, as shown in step S310. If the measurement result included in the response message Msg4 is higher than the current measurement result of the source base station A by a threshold O, the source base station A performs a handover decision and determines that the user equipment should handover to the base station B, as shown in step S311. In contrast, if the measurement result contained in the response message Msg4 is not higher the current measurement result of the source base station A by the threshold O, the source base station A performs operations of steps S304 to S306 continuously.

It should be noted that, operations of the candidate target base station are shown in FIG. 3 only taking the base station B as an example. If in step S310, the source base station A determines that each of measurement results contained in multiple response messages Msg4 from multiple candidate target base stations is higher than the current measurement result of the source base station A by the threshold O, the source base station A selects an optimal base station from the multiple candidate target base stations satisfying the condition as a handover target base station, based on energy, capacity, speed and the like of the candidate target base stations.

FIG. 4 schematically shows a curve indicating change of signal reception quality measured by the base station A and the base station B and corresponding signaling interaction according to a first embodiment of the present disclosure. As shown in FIG. 4, X_{A} and X_{B} respectively indicate change of uplink reference signal reception quality measured by the base station A and the base station B over time. For the purpose of clarity, X_{A} and X_{B} are shown as lines, while they are typically curves in practice.

At time t₁, the reception quality X_{A} measured by the base station A is lower than the initial threshold S, and the base station A transmits the message Msg1. At time t₂, the measurement result X_{B} of the base station B is higher than the initial threshold T, and the base station B transmits the response message Msg2 to the base station A. At time t₃, the base station A decreases the threshold and the measurement result X_{A} is less than the decreased threshold S−ΔS, and the base station A therefore transmits the message Msg3 to the base station B. At time t₄, the base station B increases the threshold and the measurement result X_{B} is greater than T+ΔT, and therefore the base station B transmits the response message Msg4. At time t₅, the base station A receives the response message Msg4 from the base station B, and the base station A compares the measurement result X_{B} of the base station B included in the response message Msg4 with the current measurement result X_{A} of the base station A. If X_{A}<X_{B}−O, the base station A may performs handover decision to handover to the base station B. To illustrate the principle of the present disclosure, FIG. 4 schematically shows that the base station A decreases the initial threshold one time and the base station B increases the initial threshold one time, but the actual processing may relate to multiple times of increase and decrease, as shown in FIG. 3.

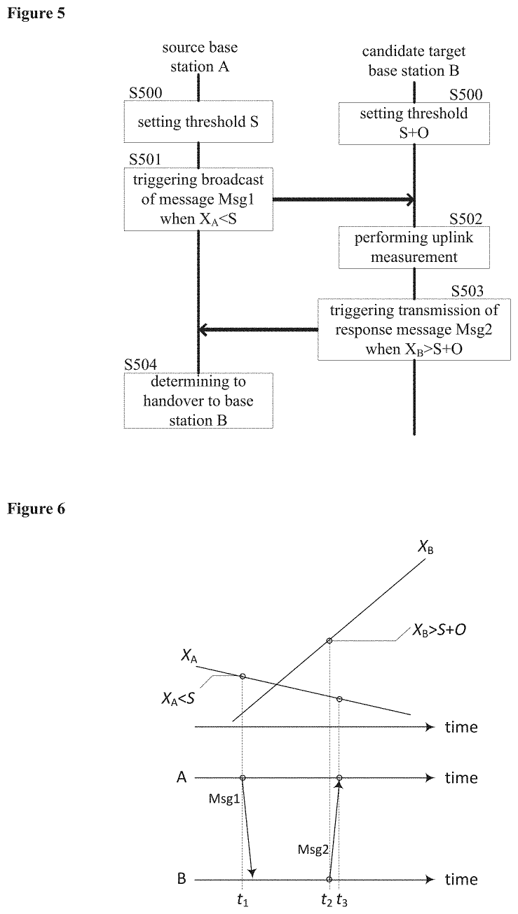

FIG. 5 shows a signaling interaction flow for performing handover decision according to a second embodiment of the present disclosure. The second embodiment illustrates a simplified solution. As compared with the first embodiment, steps S304 to S306 and steps S307 to S309 are omitted. As shown in FIG. 5, first, in step S500, the source base station A sets a threshold S, the candidate target base station B sets a threshold S+O. Herein, O is the same as the threshold O in the first embodiment. In a case that a downlink reference signal reception quality currently measured by the source base station A is lower than the threshold S, the source base station A triggers broadcast of an initial message Msg1 containing the current measurement result to all candidate target base stations (base station B is taken as an example in FIG. 5), as shown in step S501.

The candidate target base station B performs uplink measurement after receiving the initial message Msg1 from the source base station A, as shown in step S502. In a case that the measurement result of the base station B is higher than the previously set threshold S+O, the base station B triggers transmission of the response message Msg2 containing its measurement result to the source base station A, as shown in step S503. After receiving the response message Msg2, the source base station A may perform handover decision at once, and determines that the user equipment should be handover to the base station B, as shown in step S504, since the transmission of the response message Msg2 indicates that the measurement result of the base station B is higher than the measurement result of the source base station A at least by the threshold O, thereby satisfying the handover condition. Similar to FIG. 3, if the source base station A receives messages Msg2 from multiple candidate target base stations, that is, multiple candidate target base stations satisfy X_{B}>S+O, the source base station A selects an optimal base station from the multiple candidate target base stations as the handover target base station, based on energy, capacity, speed and the like of the candidate target base stations.

For the second embodiment, FIG. 6 shows a curve indicating change of signal reception quality measured by the base station A and the base station B and corresponding signaling interaction. At time t₁, the uplink reference signal reception quality X_{A} measured by the base station A is lower than the threshold S, and the base station A transmits the message Msg1. At time t₂, the measurement result X_{B} of the base station B is higher than the threshold S+O, and the base station B transmits the response message Msg2 to the base station A. At time t₃, the base station A receives the response message Msg2, and thus performs handover decision to handover to the base station B.

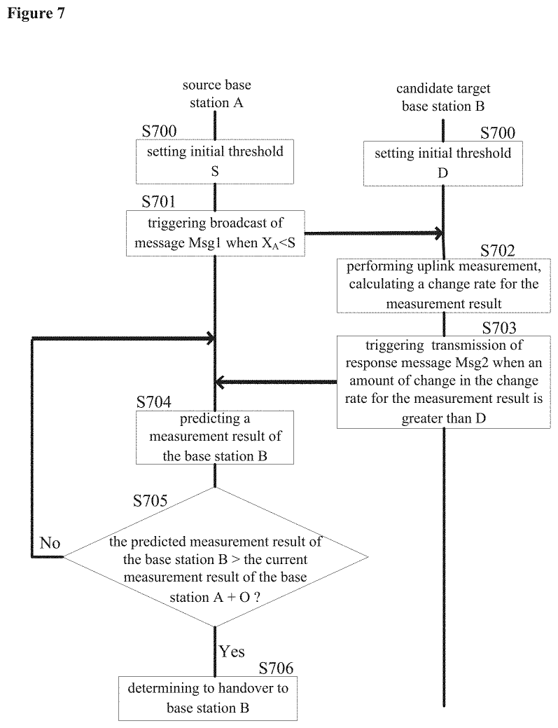

FIG. 7 shows a signaling interaction flow for performing handover decision according to a third embodiment of the present disclosure.

Reference is made to FIG. 7. First, in step S700, the source base station A sets the initial threshold S, and the candidate target base station B also sets an initial threshold D. The threshold S in the embodiment is the same as the threshold S in the first embodiment, and the threshold D may be set based on a speed of the user equipment by the base station B. In a case that the measurement result X_{A} of the uplink reference signal transmitted from the source base station A to the user equipment is lower than the threshold S, that is, when X_{A}<S, the source base station A triggers broadcast of the message Msg1 containing the measurement result of the base station A to all candidate target base stations in step S701. As described above, for clarity, FIG. 7 only shows the base station B as representative of the candidate target base stations, and other candidate target base stations are omitted.

After receiving the message Msg1 from the source base station A, the candidate target base station B measures the uplink reference signal from the user equipment in step S702, to obtain a measurement result, and calculates a change rate for the measurement result. The change rate dB(t) for the measurement result of the base station B at time t may be expressed by the following equation (1):

d_{B}(t)=[X_{B}(t)−X_{B}(t−Δt)]/Δt (1)

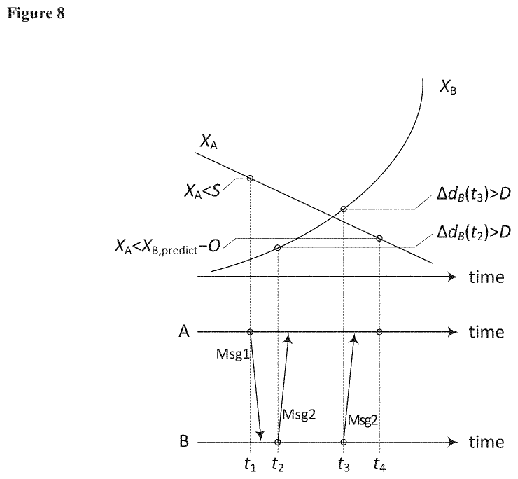

Herein, Δt indicates a time interval, X_{B}(t) indicates a measurement result of the base station B at time t, and X_{B}(t−Δt) indicates a measurement result at time t−Δt. Reference is made to FIG. 8 which shows a curve indicating change of measurement results of the base station A and the base station B. In FIG. 8, the measurement result X_{B} of the base station B is indicated as a curve. The change rate d_{B}(t) for the measurement result indicated by the equation (1) may be understood as a derivative (or slope of a tangent line) of the curve X_{B} at time t. It can be seen from FIG. 8 that the curve X_{B} has different slopes at different time moments. That is, the change rates dB(t) for the measurement results of the base station B obtained at different times are different from one another, rather than constant.

In a case that an amount of change in the change rate for the measurement result of the base station B is higher than the threshold D set in step S700, that is, when |dB(t)−dB(t′)|>D, the base station B triggers transmission of a response message Msg2 containing the measurement result X_{B}(t) and the change rate d_{B}(t) for the measurement result of the base station B at time t to the source base station A, as shown in step S703. Herein, t′ indicates a moment when the base station B performs the last triggering, and d_{B}(t′) indicates a change rate for the measurement result when the base station B performs the last triggering. It should be noted that, the base station B keeps performing uplink measurement after transmission of the response message Msg2. Therefore, with the lapse of time, the base station B may again detect that an amount of change in the change rate d_{B}(t) for the measurement result is higher than the threshold D (assuming that such case occurs at time tᵢ). When detecting this case, the base station B again triggers transmission of a new response message Msg2 containing a measurement result X_{B}(tᵢ) and a change rate d_{B}(tᵢ) for the measurement result of the base station B at time tᵢ to the source base station A. That is, step S703 may be performed multiple times, and the base station B may transmit the response message Msg2 multiple times.

Accordingly, the source base station A may receive multiple response messages Msg2 from the target candidate base station B. It is assumed that the latest response message Msg2 received by the source base station A contains the measurement result X_{B}(t_{recent}) and the change rate d_{B}(t_{recent}) for the measurement result at time t_{recent}. In this case, the source base station A predicts the measurement result of the base station B at time t_{current} based on the measurement result X_{B}(t_{recent}) and the change rate d_{B}(t_{recent}) for the measurement result at time t_{recent} included in the latest message. The time t_{current} may be any moment after the source base station A receives the latest response message. The prediction may be performed based on the following equation (2):

X_{B.predict}(t_{current})=X_{B}(t_{recent})+d_{B}(t_{recent})*(t_{current}−t_{recent}) (2).

Then, the source base station A determines whether the predicted measurement result of the base station B is higher than the current measurement result (at time t_{current}) of the source base station A by the threshold O in step S705, that is, determining whether X_{B.predict}(t_{current})>X_{A}(t_{current})+O is satisfied. If the above condition is satisfied, the source base station A decides that the user equipment should be handover to the target base station B, as shown in step S706. If the above condition is not satisfied, the source base station A performs operations before S704, that is, waits to receive the response message Msg2 from the base station B again. As described above, FIG. 7 shows only one candidate target base station B, and there are multiple candidate target base stations actually. If the source base station A determines in step S705 that X_{B.predict}(t_{current})>X_{A}(t_{current})+O is satisfied for multiple candidate target base stations B, the source base station A selects an optimal base station from the multiple candidate target base stations as the handover target based on energy, capacity, speed and the like of the candidate target base stations B.

In the embodiment, after receiving a response message, the source base station A may predict a measurement result of the base station B obtained at any moment after transmission of the response message, based on the measurement result and the change rate for the measurement result contained in the message. In a case that the change rate (slope) for the measurement result of the base station B changes greatly (for example greater than the threshold D), the measurement result cannot be accurately predicted based on the previous change rate. Therefore, the base station B is required to transmit a new response message, to notify the source base station A of a new measurement result and a change rate for the measurement result. In a case that the change rate (slope) for the measurement result of the base station B does not change greatly, the base station B is unnecessary to transmit a new response message. In this way, messages or signaling to be transmitted by the base station B can be further reduced.

FIG. 8 schematically shows a curve indicating change of measurement results of the base station A and the base station B and corresponding signaling interaction according to a third embodiment of the present disclosure. As shown in FIG. 8, line X_{A} and line X_{B} respectively indicate change of uplink reference signal reception quality measured by the base station A and the base station B over time. Particularly, to clarify the embodiment, the measurement result X_{B} of the base station B is indicated as a curve. It should be understood by those skilled in the art that the measurement result X_{A} of the base station A may also be a curve, but is indicated as a straight line in FIG. 8 for the purpose of clarity.

At time t₁, the measurement result X_{A} of the base station A is less than the initial threshold S, and the base station A transmits the message Msg1 to the base station B. At time t₂, an amount of change Δ d_{B}(t₂) in the change rate d_{B}(t₂) for the measurement result of the base station B is greater than the preset threshold D, and the base station B transmits the response message Msg2 to the base station A. At time t3, the base station B detects again that an amount of change Δ d_{B}(t₃) in the change rate d_{B}(t₃) for the measurement result is greater than preset threshold D, and the base station B transmits a new response message Msg2 to the base station A. At time t₄ (a certain moment after the base station A receives the new response message Msg2), the base station A predicts a measurement result at time t₄ of the base station B, based on the response message Msg2 recently transmitted (transmitted at the second time) by the base station B, and determines whether the predicted measurement result is higher than the measurement result at time t₄ of the base station A by the threshold O. If the predicted measurement result is higher than the measurement result at time t₄ of the base station A by the threshold O, the base station A may perform handover decision to handover the user equipment to the base station B. In order to illustrate the principle of the present disclosure, FIG. 8 shows that the base station B transmits the response message Msg2 twice. However, it should be understood by those skilled in the art that the response message Msg2 may be transmitted multiple times or only once during an actual process.

According to the embodiments of the present disclosure described with reference to the drawings, the technical solutions of effectively performing the handover decision by the source base station without the background control center are put forward in the present disclosure. According to the solutions of the present disclosure, the source base station can quickly obtain information on the candidate target base stations required for handover decision, thereby reducing signaling overhead and improving the overall performance of the handover process based on the uplink measurement.

The present disclosure may be applied to various products. For example, the base station in the above embodiments may include any type involved node B (eNB), such as macro eNB and a small eNB. The small eNB may be an eNB covering a cell smaller than the macro cell, such as a pico eNB, a micro eNB and a home (femto) eNB. Alternatively, the network side device or the base station may include any type of base station, such as NodeB and a base station transceiver station (BTS). The base station may include: a body configured to control wireless communication (also referred to as a base station device); and one or more remote radio head (RRH) arranged at a position different from that of the body. In addition, various types of terminal device may function as the base station to operate by performing the functions of the base station temporarily or in a semi-persistent manner.

In another aspect, the user equipment in the above embodiments may be implemented as a communication terminal device (such as a smartphone, a tablet personal computer (PC), a notebook PC, a portable game terminal, a portable/dongle mobile router and a digital camera) or a vehicle-mounted terminal device (such as a vehicle navigation device), and may also be implemented as a terminal device performing machine to machine (M2M) communication, which is also referred to as a machine type communication (MTC) terminal device. In addition, the terminal device or the user equipment may be a wireless communication module (such as an integrated circuit module including a single wafer) installed on each of the above terminals.

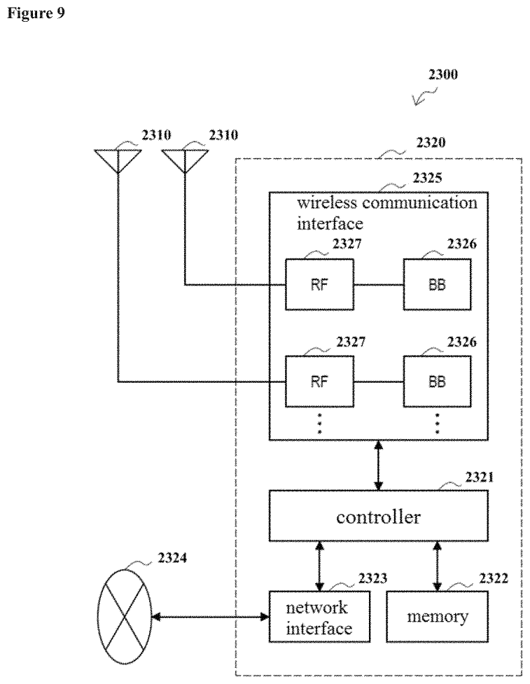

An implementation of the base station is described in conjunction with FIG. 9 by taking eNB as an example.

FIG. 9 shows a block diagram of a schematic configuration of the eNB. As shown in FIG. 9, an eNB 2300 includes one or more antennas 2310, and a base station device 2320. The base station device 2320 is connected to each antenna 2310 via a radio frequency (RF) cable.

Each of the antennas 2310 includes a single or multiple antenna elements (such as multiple antenna elements included in a multiple-input multiple-output (MIMO) antenna) and is used for the base station device 2320 to transmit and receive a wireless signal. As shown in FIG. 9, the eNB 2300 may include multiple antennas 2310. For example, the multiple antennas 2310 may be compatible with multiple frequency bands used by the eNB 2300. Although FIG. 9 shows an example in which the eNB 2300 includes multiple antennas 2310, the eNB 2300 may include a single antenna 2310.

The base station device 2320 includes a controller 2321, a memory 2322, a network interface 2323 and a wireless communication interface 2325.

The controller 2321 may be a CPU or DSP for example and controls various types of functions of higher layers of the base station device 2320. For example, the controller 2321 generates a data packet according to data in a signal processed by the wireless communication interface 2325, and transfers the generated packet via the network interface 2323. The controller 2321 may bundle data from multiple baseband processors to generate a bundle packet and transfers the generated bundle packet. The controller 2321 may have logic functions to perform the following control: such as wireless resource control, wireless bearer control, mobility management, admission control and schedule. The control may be implemented in conjunction with an eNB or a core network node nearby. The memory 2322 includes an RAM and an ROM and stores programs performed by the controller 2321 and various types of control data (such as a terminal list, transmission power data and schedule data).

The network interface 2323 is a communication interface connecting a base station device 2320 to a core network 2324. The controller 2321 may communicate with a core network node or another eNB via the network interface 2323. In this case, the eNB 2300 may be connected to the core network node or other eNB via a logic interface (such as an Si interface and an X2 interface). The network interface 2323 may also be a wired communication interface or a wireless communication interface for a wireless backhaul line. If the network interface 2323 is a wireless communication interface, the network interface 2323 may use a higher frequency band for wireless communication as compared with a frequency band used by the wireless communication interface 2325.

The wireless communication interface 2325 supports any cellular communication scheme (such as Long Term Evolution and LTE-advanced), and provide wireless connection to a terminal in a cell of the eNB 2300 via an antenna 2310. The wireless communication interface 2325 may generally include a baseband (BB) processor 2326 and an RF circuit 2327. The BB processor 2326 may perform for example encoding/decoding, modulating/demodulating and multiplexing and de-multiplexing and perform various types of signal processing of layers (such as L1, medium access control (MAC), radio link control (RLC) and packet data convergence protocol (PDCP). Instead of a controller 2321, the BB processor 2326 may have a part or all of the logic functions described above. The BB processor 2326 may be a memory storing communication control programs, or a module including a processor and related circuits configured to perform programs. Updating programs may change functions of the BB processor 2326. The module may be a card or a blade inserted to a slot of the base station device 2320. Alternatively, the module may also be a chip installed on the card or the blade. Meanwhile, an RF circuit 2327 may include for example a mixer, a filter and an amplifier, and transmits and receives a wireless signal via the antenna 2310.

As shown in FIG. 9, the wireless communication interface 2325 may include multiple BB processors 2326. For example, the multiple BB processors 2326 may be compatible with multiple frequency bands used by the eNB 2300. As shown in FIG. 9, the wireless communication interface 2325 may include multiple RF circuits 2327. For example, the multiple RF circuits 2327 may be compatible with multiple antenna elements. Although FIG. 9 shows an example in which the wireless communication interface 2325 includes multiple BB processors 2326 and multiple RF circuits 2327, the wireless communication interface 2325 may include a single BB processor 2326 or a single RF circuit 2327.

In the eNB 2300 shown in FIG. 9, the transceiving apparatus of the base station side device may be implemented by the wireless communication interface 2325. At least a part of functions of various units may be achieved by the controller 2321. For example, the controller 2321 may perform at least a part of functions of various units by executing program stored in the memory 2322.

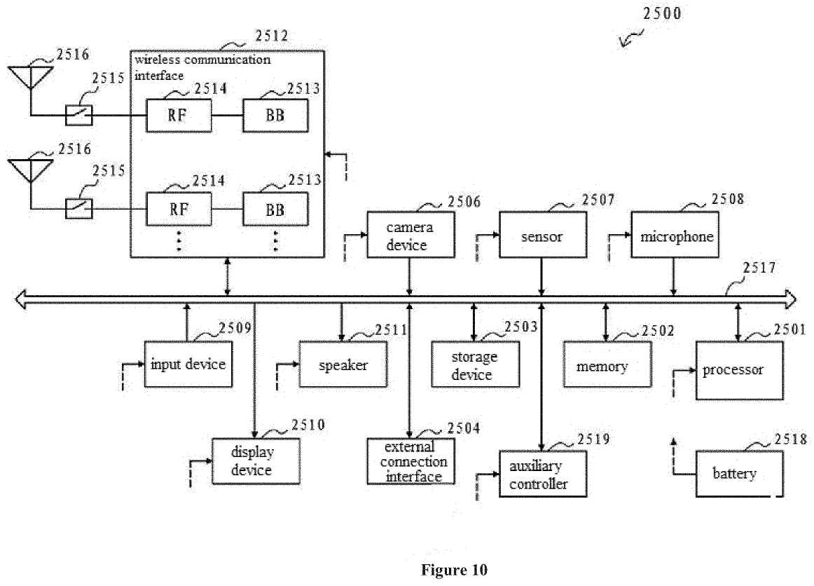

An implementation of user equipment is described with reference to FIG. 10 by taking a smartphone as an example.

FIG. 10 is a block diagram showing a schematic configuration of a smart phone. As shown in FIG. 10, the smart phone 2500 includes: a processor 2501, a memory 2502, a storage apparatus 2503, an external connection interface 2504, a camera device 2506, a sensor 2507, a microphone 2508, an input apparatus 2509, a display apparatus 2510, a speaker 2511, a wireless communication interface 2512, one or more antenna switches 2515, one or more antennas 2516, a bus 2517, a battery 2518 and an auxiliary controller 2519.

The processor 2501 may be for example a CPU or a system on chip (SoC), and control functions of an application layer and other layers of the smart phone 2500. The memory 2502 includes an RAM and an ROM, and stores programs executed by the processor 2501 and data. The storage apparatus 2503 may include a storage medium, such as a semiconductor memory and a hard disk. The external connection interface 2504 is an interface configured to connect an external apparatus (such as a memory card and a universal serial bus (USB) device) to the smart phone 2500.

The camera device 2506 includes an image sensor (such as a charge coupled device (CCD) and a complementary metal oxide semiconductor (CMOS)) and generates a captured image. The sensor 2507 may include a set of sensors, such as a measurement sensor, a gyroscope sensor, a geomagnetic sensor and an acceleration sensor. The microphone 2508 converts sound inputted into the smart phone 2500 into an audio signal. The input apparatus 2509 includes for example a touch sensor configured to detect touch on a screen of the display apparatus 2510, a keypad, a keyboard, a button or a switch, and receives an operation or information inputted from a user. The display apparatus 2510 includes a screen (such as a liquid crystal display (LCD) and an organic light emitting diode (OLED) display), and displays an output image of the smart phone 2500. The speaker 2511 converts the audio signal outputted from the smart phone 2500 into sound.

The wireless communication interface 2512 supports any cellular communication scheme (such as LTE and LTE-advanced), and performs wireless communication. The wireless communication interface 2512 may generally include for example a BB processor 2513 and an RF circuit 2514. The BB processor 2513 may perform encoding/decoding, modulating/demodulating and multiplexing/de-multiplexing for example, and perform various types of signal processing for wireless communication. Meanwhile, the RF circuit 2514 may include for example a mixer, a filter and an amplifier, and transmits and receives a wireless signal via an antenna 2516. The wireless communication interface 2512 may be a chip module on which a BB processor 2513 and the RF circuit 2514 are integrated. As shown in FIG. 10, the wireless communication interface 2512 may include multiple BB processors 2513 and multiple RF circuits 2514. However, the wireless communication interface 2512 may include a single BB processor 2513 or a single RF circuit 2514.

In addition to the cellular communication scheme, the wireless communication interface 2512 may support other types of wireless communication schemes, such as a short distance wireless communication scheme, a near field communication scheme and a wireless local area network (LAN) scheme. In this case, the wireless communication interface 2512 may include a BB processor 2513 and an RF circuit 2514 for each type of wireless communication scheme.

Each of the wireless switches 2515 switches a connection destination of the antenna 2516 between multiple circuits (for example circuits for different wireless communication schemes) included in the wireless communication interface 2512.

Each of the antennas 2516 includes a single or multiple antenna elements (such as multiple antenna elements included in the MIMO antenna), and is used for the wireless communication interface 2512 to transmit and receive a wireless signal. As shown in FIG. 10, the smart phone 2500 may include multiple antennas 2516. However, the smart phone 2500 may include a single antenna 2516.

In addition, the smart phone 2500 may include an antenna 2516 for each type of wireless communication scheme. In this case, the antenna switch 2515 may be omitted from the configuration of the smart phone 2500.

The bus 2517 connects the processor 2501, the memory 2502, the storage apparatus 2503, the external connection interface 2504, the camera device 2506, the sensor 2507, the microphone 2508, the input apparatus 2509, the display apparatus 2510, the speaker 2511, the wireless communication interface 2512 and the auxiliary controller 2519 with each other. The battery 2518 supplies power for components in the smart phone 2500 via a feeder which is indicated partially as a dashed line in the figure. The auxiliary controller 2519 controls a minimum necessary function of the smart phone 2500 in a sleeping mode, for example.

In the smart phone 2500 shown in FIG. 10, the transceiving apparatus of the terminal device may be implemented by the wireless communication interface 2512. At least a part of functions of various functional units of the terminal device may be implemented by the processor 2501 or the auxiliary controller 2519. For example, power consumption of the battery 2518 may be reduced by achieving a part of functions of the processor 2501 by the auxiliary controller 2519. In addition, the processor 2501 or the auxiliary controller 2519 may achieve at least a part of functions of various functional units of the terminal device by executing programs stored in the memory 2502 or the storage apparatus 2503.

In addition, a series of processing performed by each device or unit in the above embodiments may be implemented by software, hardware, or a combination of software and hardware. Programs included in the software may be stored in each device or unit or an external storage medium in advance, for example. As an example, during performing, the programs are written into a random access memory (RAM) and are executed by a processor (such as a CPU), thereby performing the method and processing described in the above embodiments. The present disclosure includes the program codes and program products, and the computer readable recording medium on which the program codes are recorded.

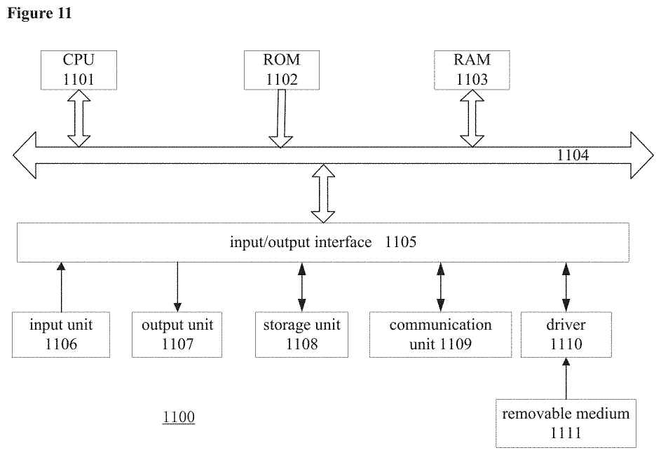

FIG. 11 is a block diagram showing a schematic configuration of hardware of a computer which performs solutions of the present disclosure according to programs.

In a computer 1100, a central processing unit (CPU) 1101, a read only memory (ROM) 1102 and a random access memory (RAM) 1103 are connected to each other via a bus 1104.

An input/output interface 1105 is further connected to a bus 1104. The following components are connected to the input/output unit 1105: an input unit 1106 such as a keyboard, a mouse or a microphone; an output unit 1107 such as a display or a loudspeaker; a storage unit 1108 such as a hard disk, a non-volatile memory; a communication unit 1109 such as a network interface card (for example a local area network (LAN) card, and a modem); and a driver 1110 for driving a removable medium 1111. The removable medium 1111 may be for example a magnetic disk, an optical disk, a magnetic-optical disk, and a semiconductor memory.

In the computer having the above structure, the CPU 1101 loads programs stored in the storage unit 1108 into the RAM 1103 via the input/output interface 1105 and the bus 1104, and executes the programs, thereby performing the above processing.

Programs to be executed by the computer (the CPU 1101) may be recorded on the removable medium 1111 as a package medium. The package medium may be formed by for example a magnetic disk (including a floppy disk), an optical disk (including compact disk read only memory (CD-ROM)), digital versatile disk (DVD), a magnetic-optical disk or a semiconductor memory. In addition, programs to be executed by the computer (the CPU 1101) may be provided by wired or wireless transmission media such as a local area network, the Internet or a digital satellite broadcast.

In a case that the removable medium 1111 is installed in the driver 1110, the programs may be installed in the storage unit 1108 via the input/output interface 1105. In addition, the programs may be received by the communication unit 1109 via wired or wireless transmission medium, and the programs are installed in the storage unit 1108. Alternatively, the programs may be installed in the ROM 1102 or the storage unit 1108 in advance.

The programs to be executed by the computer may be programs for performing processing in an order described in the specification, or the programs for performing the processing in parallel or as needed (for example, when being called).

The devices or units are described herein only in a logical meaning, and do not strictly correspond to the physical device or entities. For example, functions of each unit described herein may be implemented by multiple physical entities. Alternatively, the function of multiple units described herein may be implemented by a single physical entity. In addition, it should be noted that, features, components, elements, steps and the like described in one embodiment are not limited to be applied in the embodiment, but may be applied to other embodiments, for example, replacing specific features, components, elements, steps and the like in other embodiments, or combined with the specific features, components, elements, steps in other embodiments.

The embodiments of the present disclosure and the technical effects are described in detail above in conjunction with the drawings, but the scope of the present disclosure is not limited thereto. It should be understood by those skilled in the art that, depending on design requirements and other factors, various changes or modifications may be made to the embodiments discussed herein without departing from the principles and spirit of the present disclosure. The scope of the present disclosure is defined by the attached claims and the equivalent solutions thereof.

In addition, the following configurations are provided according to the present disclosure.

A communication method performed by a base station, including: measuring a first reception quality of an uplink reference signal broadcasted by a terminal device; generating an initial message for instructing a neighbor base station to measure a second reception quality of the uplink reference signal, when the first measured reception quality is lower than a preset first threshold; and determining whether to instruct the terminal device to handover to the neighbor base station based on a response message from the neighbor base station, where the response message indicates the second reception quality measured by the neighbor base station.

The communication method further includes: decreasing the first threshold; measuring the first reception quality of the uplink reference signal after decreasing the first threshold; and generating a notification message indicating the measured first reception quality to transmit the notification message to the neighbor base station, when the measured first reception quality is lower than the decreased first threshold.

The communication method further includes: decreasing the first threshold a number of times, and measuring the first reception quality of the uplink reference signal every time the first threshold is decreased; and generating and transmitting the notification message a number of times.

The communication method further includes: decreasing the first threshold a number of times by decreasing the first threshold by a first predetermined value each time, where the first predetermined value is set based on a speed of the terminal device.

The communication method further includes: instructing the terminal device to handover to the neighbor base station when the second reception quality measured by the neighbor base station is higher than the first reception quality measured by the base station by a certain threshold.

The communication method further includes: instructing the terminal device to handover to the neighbor base station upon receipt of the response message from the neighbor base station.

The communication method further includes: predicting, based on the response message from the neighbor base station, the second reception quality measured by the neighbor base station after the response message is transmitted; and instructing the terminal device to handover to the neighbor base station when the predicted second reception quality of the neighbor base station is higher than the first reception quality measured by the base station by a certain threshold.

When multiple neighbor base stations meet one of conditions including: the second reception quality measured by the neighbor base station is higher than the first reception quality measured by the base station by a certain threshold; the response message from the neighbor base station is received; and the predicted second reception quality of the neighbor base station is higher than the first reception quality measured by the base station by a certain threshold, one of the multiple neighbor base stations is selected as a base station to which the terminal device is to handover, based on energy, capacity or speed of the multiple neighbor base stations.

The first threshold is preset based on at least one of radius of a cell, transmission power, electromagnetic wave propagation environment, and requirement on signal to interference ratio.

The certain threshold is preset based on at least one of radius of a cell, transmission power, electromagnetic wave propagation environment, requirement on signal to interference ratio, and experience and preference of an operator.

A communication method performed by a base station, including:

measuring a first reception quality of an uplink reference signal broadcasted by a terminal device upon receipt of an initial message from a neighbor base station; and generating a response message indicating the measured first reception quality to transmit the response message to the neighbor base station, where the neighbor base station generates the initial message based on a second reception quality of the uplink reference signal measured by the neighbor base station.

The communication method further includes: increasing a preset second threshold; measuring the first reception quality of the uplink reference signal after increasing the second threshold; and transmitting the response message when the measured first reception quality is higher than the increased second threshold.

The communication method further includes: increasing the second threshold a number of times, and measuring the first reception quality of the uplink reference signal every time the second threshold is increased; and generating and transmitting the response message a number of times.

The communication method further includes: increasing the second threshold a number of times by increasing the second threshold by a second predetermined value each time, where the second predetermined value is set based on a speed of the terminal device.

The neighbor base station generates the initial message when the second reception quality measured by the neighbor base station is lower than a first threshold, the communication method further including: transmitting the response message when the first reception quality measured by the base station is higher than the first threshold by a certain threshold.

The communication method further includes: transmitting the response message when an amount of change in changing rate of the first reception quality measured by the base station is larger than a third threshold, where the response message indicates the first reception quality measured by the base station and the changing rate of the measured first reception quality.

The first and second thresholds are preset based on at least one of radius of a cell, transmission power, electromagnetic wave propagation environment, and requirement on signal to interference ratio.

The third threshold is preset based on a speed of the terminal device.

The certain threshold is preset based on at least one of radius of a cell, transmission power, electromagnetic wave propagation environment, requirement on signal to interference ratio, and experience and preference of an operator.

A base station device including a processing circuitry configured to perform the communication method described above.

A computer-readable recording medium storing a program which, when being executed, causes a computer to execute the communication method described above.

1. A communication method performed by a base station, comprising:
measuring a first reception quality of an uplink reference signal broadcasted by a terminal device;
generating an initial message for instructing a neighbor base station to measure a second reception quality of the uplink reference signal, when the first measured reception quality is lower than a preset first threshold; and
determining whether to instruct the terminal device to handover to the neighbor base station based on a response message from the neighbor base station, wherein the response message indicates the second reception quality measured by the neighbor base station.

2. The communication method according to claim 1, further comprising:
decreasing the first threshold;
measuring the first reception quality of the uplink reference signal after decreasing the first threshold; and
generating a notification message indicating the measured first reception quality to transmit the notification message to the neighbor base station, when the measured first reception quality is lower than the decreased first threshold.

3. The communication method according to claim 2, further comprising:
decreasing the first threshold a number of times, and measuring the first reception quality of the uplink reference signal every time the first threshold is decreased; and
generating and transmitting the notification message a number of times.

4. The communication method according to claim 3, further comprising:
decreasing the first threshold a number of times by decreasing the first threshold by a first predetermined value each time,
wherein the first predetermined value is set based on a speed of the terminal device.

5. The communication method according to claim 1, further comprising:
instructing the terminal device to handover to the neighbor base station when the second reception quality measured by the neighbor base station is higher than the first reception quality measured by the base station by a certain threshold.

6. The communication method according to claim 1, further comprising: instructing the terminal device to handover to the neighbor base station upon receipt of the response message from the neighbor base station.

7. The communication method according to claim 1, further comprising:
predicting, based on the response message from the neighbor base station, the second reception quality measured by the neighbor base station after the response message is transmitted; and
instructing the terminal device to handover to the neighbor base station when the predicted second reception quality of the neighbor base station is higher than the first reception quality measured by the base station by a certain threshold.

8. The communication method according to claim 5, wherein when a plurality of neighbor base stations meet one of conditions including:
the second reception quality measured by the neighbor base station is higher than the first reception quality measured by the base station by a certain threshold;
the response message from the neighbor base station is received; and
the predicted second reception quality of the neighbor base station is higher than the first reception quality measured by the base station by a certain threshold,
one of the plurality of neighbor base stations is selected as a base station to which the terminal device is to handover, based on energy, capacity or speed of the plurality of neighbor base stations.

9. The communication method according to claim 1, wherein the first threshold is preset based on at least one of radius of a cell, transmission power, electromagnetic wave propagation environment, and requirement on signal to interference ratio.

10. The communication method according to claim 5, wherein the certain threshold is preset based on at least one of radius of a cell, transmission power, electromagnetic wave propagation environment, requirement on signal to interference ratio, and experience and preference of an operator.

11. A base station device comprising a processing circuitry configured to perform the communication method according to claim 1.

12. (canceled)

13. A communication method performed by a base station, comprising:
measuring a first reception quality of an uplink reference signal broadcasted by a terminal device upon receipt of an initial message from a neighbor base station; and
generating a response message indicating the measured first reception quality to transmit the response message to the neighbor base station,
wherein the neighbor base station generates the initial message based on a second reception quality of the uplink reference signal measured by the neighbor base station.

14. The communication method according to claim 13, further comprising: increasing a preset second threshold;
measuring the first reception quality of the uplink reference signal after increasing the second threshold; and
transmitting the response message when the measured first reception quality is higher than the increased second threshold.

15. The communication method according to claim 14, further comprising:
increasing the second threshold a number of times, and measuring the first reception quality of the uplink reference signal every time the second threshold is increased; and
generating and transmitting the response message a number of times.

16. The communication method according to claim 15, further comprising:
increasing the second threshold a number of times by increasing the second threshold by a second predetermined value each time,
wherein the second predetermined value is set based on a speed of the terminal device.

17. The communication method according to claim 13, wherein the neighbor base station generates the initial message when the second reception quality measured by the neighbor base station is lower than a first threshold,
the communication method further comprising:
transmitting the response message when the first reception quality measured by the base station is higher than the first threshold by a certain threshold.

18. The communication method according to claim 13, further comprising:
transmitting the response message when an amount of change in changing rate of the first reception quality measured by the base station is larger than a third threshold,
wherein the response message indicates the first reception quality measured by the base station and the changing rate of the measured first reception quality.

19. The communication method according to claim 14, wherein the first and second thresholds are preset based on at least one of radius of a cell, transmission power, electromagnetic wave propagation environment, and requirement on signal to interference ratio.

20. The communication method according to claim 18, wherein the third threshold is preset based on a speed of the terminal device.

21. The communication method according to claim 17, wherein the certain threshold is preset based on at least one of radius of a cell, transmission power, electromagnetic wave propagation environment, requirement on signal to interference ratio, and experience and preference of an operator.

22.-23. (canceled)
